(19) United States
(12) Patent Application Publication
(10) Pub. No.: US 2021/0377285 A1
(43) Pub. Date: Dec. 2, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Ye SUN, Kanagawa (JP); Tatsuo SUZUKI, Kanagawa (JP)

(73) Assignee: FUJIFILM Business Innovation Corp., Tokyo (JP)

(21) Appl. No.: 17/098,462

(22) Filed: Nov. 16, 2020

(30) Foreign Application Priority Data
May 28, 2020 (JP) 2020-093234

(51) Int. Cl. H04L 29/06; H04L 29/12; G06N 20/00

(52) U.S. Cl. CPC H04L 63/1416; H04L 61/1511; G06N 20/00; H04L 63/1425; H04L 63/145

(57) ABSTRACT

An information processing apparatus includes a processor configured to detect an unauthorized communication from an originating terminal by inputting a target query type string of the originating terminal serving as a detection target to a learner that has learned a feature of a query type string of the originating terminal through unsupervised learning with the query type string used as learning data. The query type string includes query types arranged in time sequence and is included in an information request signal that is transmitted to a domain name system (DNS) server in response to a request of the originating terminal.

### CROSS-REFERENCE TO RELATED APPLICATIONS

This application is based on and claims priority under 35 USC 119 from Japanese Patent Application No. 2020-093234 filed May 28, 2020.

### BACKGROUND

### (i) Technical Field

The present disclosure relates to an information processing apparatus and a non-transitory computer readable medium.

### (ii) Related Art

Malware is known as unscrupulous software. An originating terminal infected with malware may perform communication with a destination host, sometimes against the will of a user of the originating terminal (such communication is hereinafter referred to as an unauthorized communication in this specification).

Techniques of detecting whether an originating terminal is infected with malware have been disclosed. For example, Japanese Unexamined Patent Application Publication No. 2018-133004 discloses a fault detection system. The fault detection system detects whether an Internet of things (IoT) terminal is infected with malware, based on a feature quantity. The feature quantity is the number of types of destination hosts or the frequency of occurrence of communications between the IoT terminal as an originating terminal and a destination host. Japanese Patent No. 6078179 discloses a security threat system. The security threat system detects a security attack packet by causing a learner to learn a communication pattern of a security attack communication from header information of the security attack packet (unscrupulous packet) traveling through a network.

An originating terminal infected with malware may be connected to a variety of destination hosts in a variety of communication modes. It is thus difficult to define beforehand the destination hosts and communication modes of the originating terminal infected with malware. Even when a learner is used, it is still difficult to cause the learner to learn the communication modes. Detecting an unauthorized communication based on the communication mode of the malware is thus difficult. Specifically, if a communication from the originating terminal is established, it is difficult to determine whether the communication is based on malware, in other words, whether the communication is an unauthorized communication.

### SUMMARY

Aspects of non-limiting embodiments of the present disclosure relate to detecting an unauthorized communication from an originating terminal.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a processor configured to detect an unauthorized communication from an originating terminal by inputting a target query type string of the originating terminal serving as a detection target to a learner that has learned a feature of a query type string of the originating terminal through unsupervised learning with the query type string used as learning data. The query type string includes query types arranged in time sequence and is included in an information request signal that is transmitted to a domain name system (DNS) server in response to a request of the originating terminal.

### BRIEF DESCRIPTION OF THE DRAWINGS

Exemplary embodiment of the present disclosure will be described in detail based on the following figures, wherein:

FIG. 1 illustrates a configuration of a network system of an exemplary embodiment;

FIG. 2 illustrates an example of a communication log;

FIG. 3 illustrates a configuration of a security server of the exemplary embodiment;

FIG. 4 illustrates a structure of a learner;

FIG. 5 illustrates a query type string of each originating terminal;

FIG. 6 is a first chart illustrating entry learning data and evaluation data in a query type string;

FIG. 7 is a second chart illustrating the entry learning data and evaluation data in the query type string;

FIG. 8 illustrates a process of the learner having received the query type string;

FIG. 9 illustrates an example of the query type string into which an element having a blank time is inserted;

FIG. 10 illustrates an individual score of each query type included in a target query type string; and

FIG. 11 illustrates an example of a graph of an evaluation score.

### DETAILED DESCRIPTION

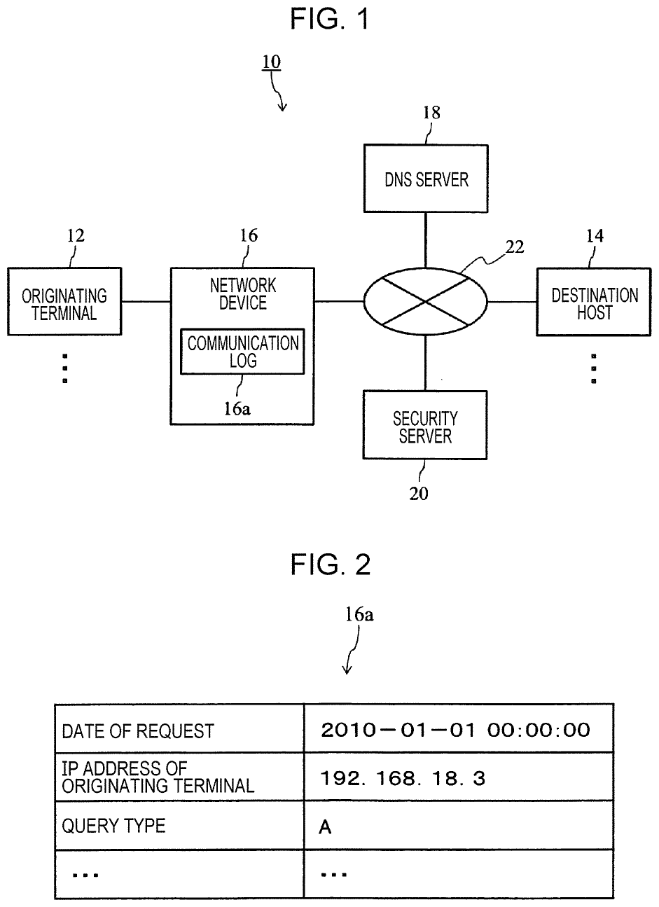

FIG. 1 illustrates a configuration of a network system 10 of an exemplary embodiment. The network system 10 includes one or more originating terminals 12, one or more destination hosts 14, network device 16, domain name system (DNS) server 18, and security server 20. The security server 20 is an example of an information processing apparatus of the exemplary embodiment of the disclosure. The originating terminal 12 and network device 16 are communicably connected to each other via an Intranet, such a local area network (LAN). The destination host 14, network device 16, DNS server 18, and security server 20 are communicably connected to each other via a communication network 22 including the Internet and LAN.

The originating terminal 12 is used by a user and, for example, is a personal computer. The originating terminal 12 may be a mobile terminal, such as a tablet terminal. The originating terminal 12 includes a communication interface, memory, display, input interface, and processor. The communication interface is used to communicate with the network device 16 or with the destination host 14 via the network device 16. The memory includes a hard disk, read-only memory (ROM), and/or random-access memory (RAM). The display is a liquid-crystal display. The input interface includes a mouse, keyboard, and/or touch panel. The processor includes a central processing unit (CPU) and a microcomputer.

The originating terminal 12 could be infected with malware. The malware is a general term indicating unscrupulous software or code that is intended to operate the originating terminal 12 illegally and maliciously. Malware could intrude the originating terminal 12 via a variety of routes. For example, if a threatening destination host 14 sends malware to the originating terminal 12, the originating terminal 12 may be infected with the malware. If an external memory (such as a universal serial bus (USB)) infected with malware is connected to the originating terminal 12, the originating terminal 12 may be infected.

The destination host 14 may be a server (such as a web server) and may provide a variety of data (such as webpage data) to an accessing device via the communication network 22. Using a virtual host, multiple destination hosts 14 may be virtually defined on a single server.

The network device 16 is connected over a communication line between the originating terminal 12 and the destination host 14. The network device 16 transmits a variety of information request signals as requests to the DNS server 18 in response to a request from the originating terminal 12. For example, when a user specifies a uniform resource locator (URL) of the destination host 14 on the originating terminal 12 (namely, when the originating terminal 12 tries communicating with the destination host 14), the network device 16 transmits to the DNS server 18 a request for name resolution of fully qualified domain name (FQDN, such as “www.fujixerox.co.jp”) indicating the destination host 14 and included in the URL. To acquire not only the name resolution but also a variety of information (such as a comment on FQDN) stored on the DNS server 18, the network device 16 transmits the request to the DNS server 18.

The request that the network device 16 transmits to the DNS server 18 includes a query type (also referred to as a DNS record type) indicating the type of information requested to the DNS server 18. The query type is not limited to this type. For example, the query types may include “A” indicating an IP address of FQDN in IPv4 format, “AAAA” indicating the IP address of FQDN in the IPv6 format, “CNAME” indicating an alias of FQDN (alias domain name), and “TXT” indicating text information, such as a comment relating to FQDN. For example, in order to acquire the IP address in the IPv4 format of FQDN, the network device 16 transmits to the DNS server 18 the request including FQDN and the query type “A.”

Each time a request is transmitted from the network device 16 to the DNS server 18, a communication log 16a indicating a transmission log of the request is accumulated on the network device 16. FIG. 2 illustrates an example of the communication log 16a of a request. The communication log 16a includes a date of the request when the request is transmitted to the DNS server 18, the IP address of the originating terminal 12 which has requested the network device 16 to transmit the request, and information on the query type of the request. The IP address of the originating terminal 12 is used as an identifier uniquely identifying the originating terminal 12. As long as the IP address of the originating terminal 12 uniquely identifies the originating terminal 12, another piece of information in place of the IP address of the originating terminal 12 may be included in the communication log 16a.

The network device 16 performs a process assuring security when the originating terminal 12 communicates with the destination host 14 via the communication network 22. For example, the network device 16 examines data (for example, a packet) transmitted from the destination host 14. The network device 16 includes a firewall or an intrusion prevention system (IDS). If the network device 16 determines that the data is unauthorized (the data adversely affects the originating terminal 12 or the data has a possibility that adversely affects the originating terminal 12), the network device 16 blocks the communication between the originating terminal 12 and the destination host 14 with the firewall or the IDS.

According to the exemplary embodiment, the network device 16 is connected to the originating terminal 12. In response to a request from each originating terminal 12, the network device 16 performs a process of transmitting a request to the DNS server 18 and a process of assuring security in the communication between the originating terminal 12 and the destination host 14.

The DNS server 18 is designed to transmit a variety of information in response to a request from a variety of devices, such as the network device 16. The DNS server 18 in particular performs mutual conversion between the domain name and the IP address. Upon receiving a request from the network device 16, the DNS server 18 transmits to the network device 16 information responsive to a query type included in the request.

The DNS server 18 may now receive from the network device 16 a request including FQDN of the destination host 14 specified by the originating terminal 12 and a query type “A.” The DNS server 18 performs a name resolution process for the FQDN and identifies the IP address in the IPv4 format of the destination host 14 indicated by the FQDN. According to the exemplary embodiment, the DNS server 18 is a full-service resolver and performs the name resolution process in cooperation with one or more name servers (not illustrated).

The name server is an authoritative server and manages domain names within a specific range. For example, one name server manages domain names “xxx.net” and another name server manages domain names “xxx.org”. Specifically, the name server has a zone file including information on a domain name within a range managed by the name server. By referring to the zone file, the name server recognizes the range of the domain names managed by the name server itself.

The DNS server 18 transmits the FQDN received from the network device 16 to multiple name servers. A name server managing the FQDN from among the name servers having received the FQDN identifies the IP address corresponding to the FQDN by referring to the zone file of the name server. The name server transmits the identified IP address to the DNS server 18. The DNS server 18 then transmits the IP address received from the name server (the IP address of the destination host 14) to the network device 16.

The DNS server 18 and at least some of the name servers may be integrated into a unitary body. In such a case, the DNS server 18 manages the domain names within a given range, specifically, the DNS server 18 has the zone file including the information on the domain names within the given range.

The network device 16 having received from the DNS server 18 the IP address of the destination host 14 is accessible to the destination host 14 in accordance with the IP address.

The DNS server 18 (and the name server) stores a correspondence relationship between the domain name and the IP address and other verity of information. For example, the DNS server 18 stores the alias of each domain name and text information attached to each domain name. In response to the request from the originating terminal 12, the network device 16 may acquire desired information from the DNS server 18 by setting a query type included in the request.

The security server 20 includes a server computer. The security server 20 detects an unauthorized communication from the originating terminal 12. Specifically, the security server 20 detects a communication that is from a malware-infected originating terminal 12 to the destination host 14 and is against the will of the user of the originating terminal 12. If the security server 20 detects an unauthorized communication, the originating terminal 12 having attempted to perform the unauthorized communication is determined to be infected with malware. The security server 20 thus determines whether or not the originating terminal 12 has been infected with malware.

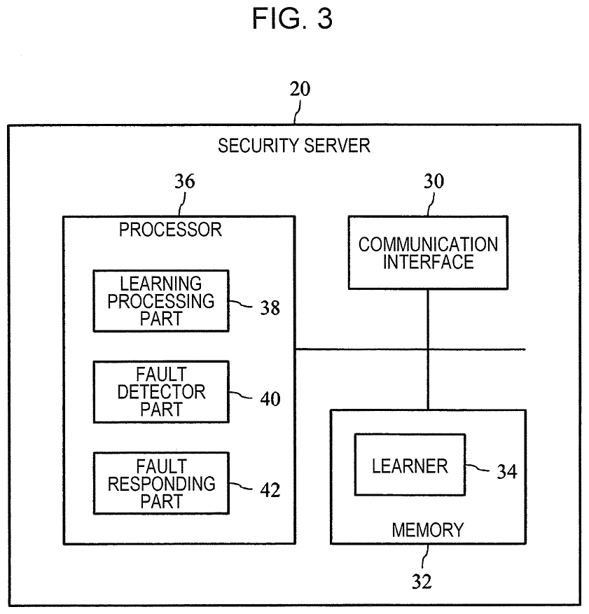

FIG. 3 illustrates a configuration of the security server 20. Referring to FIG. 3, the security server 20 is described.

The communication interface 30 includes a network adapter. The communication interface 30 exhibits the function of communicating with another device (such as the network device 16) via the communication network 22.

The memory 32 includes a hard disk, solid-state drive (SSD), ROM, and/or RAM. The memory 32 may be external to a processor 36 described below or at least part of the memory 32 may be internal to the processor 36. The memory 32 stores an information processing program that operates each element of the security server 20. Referring to FIG. 3, the memory 32 stores a learner 34.

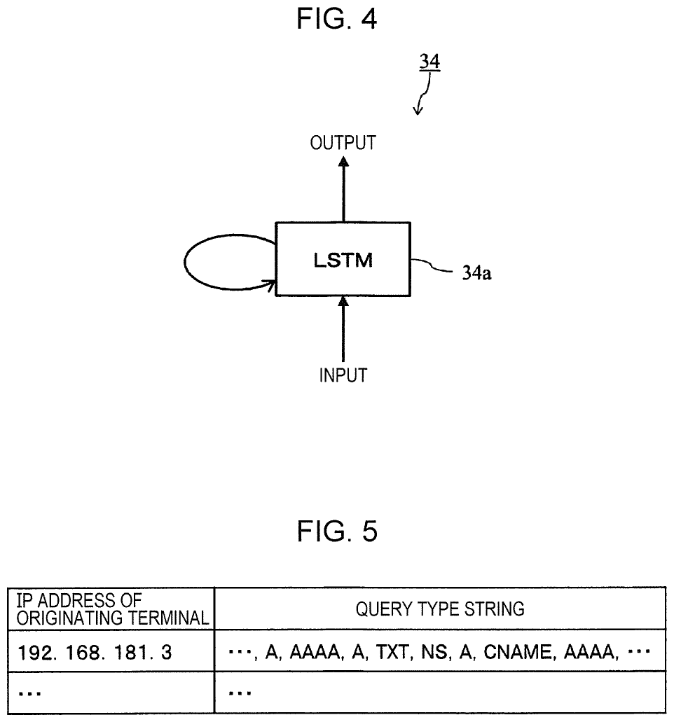

The learner 34 is configured to be a recurrent neural network (RNN) model. FIG. 4 illustrates the model of the learner 34 of the exemplary embodiment. According to the exemplary embodiment, the learner 34 includes a long short-term memory (LSTM) 34a that is an extended version of the RNN. The LSTM 34a receives sequentially arranged input data. The LSTM 34a receives an output responsive to previously input data and next input data together. In this way, the LSTM 34a may thus output next input data in view of the feature of the previously input data. The learner 34 is also referred to as a recurrent neural network. The learner 34 is actually a computer program defining the structure of the learner 34 and a process execution program that processes a variety of parameters related to the learner 34 and input data of the learner 34. The storage of the learner 34 on the memory 32 is intended to mean that the programs and the parameters are stored on the memory 32. The learning process of the learner 34 is described below together with the process of a learning processing part 38.

The processor 36 refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device). The processor 36 is broad enough to encompass one processor or plural processors in collaboration which are located physically apart from each other but may work cooperatively. Referring to FIG. 3, the processor 36 performs the functions of the learning processing part 38, fault detector part 40, and fault responding part 42 in accordance with an information processing program stored on the memory 32.

The learning processing part 38 performs a learning process using learning data that is based on the communication log 16a received from the network device 16.

The learning processing part 38 differentiates the communication logs 16a according to each originating terminal 12, based on information identifying the originating terminal 12 included in the communication log 16a (the IP address of the originating terminal in the exemplary embodiment). In accordance with the dates of requests included in the communication logs 16a, the learning processing part 38 arranges the communication logs 16a in the order of transmission of the corresponding requests on each originating terminal 12. The learning processing part 38 extracts query types from the communication logs 16a that are arranged in time sequence. The learning processing part 38 thus acquires the query type string on each originating terminal 12. The query type string includes query types that arranged in the time sequence order (the order of transmission). FIG. 5 illustrates an example of the query type string acquired by the learning processing part 38.

The learning processing part 38 causes the learner 34 to learn on each originating terminal 12 using as the learning data the thus acquired query type string on each originating terminal 12. Specifically, the learning processing part 38 learns to cause the learner 34 to output the feature of the input query type string. Causing the learner 34 to learn on each originating terminal 12 is intended to mean that the learning data and information identifying the originating terminal 12 are input to the learner 34 or that the learner 34 is prepared for each originating terminal 12. In the following discussion, the learner 34 is caused to learn on a specific single originating terminal 12. According to the exemplary embodiment, the learner 34 includes the LSTM 34a and the learning process is performed as described below. As long as the feature of the input query type string is output, the learner 34 may not necessarily be in the same structure as described above and the learning method adopted may not necessarily be the same method as described below.

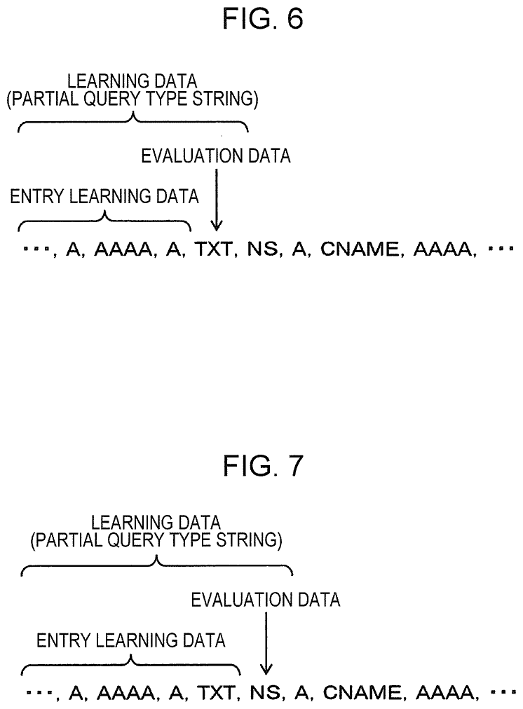

The query type string includes multiple query types arranged in a string. To increase the number of pieces of the learning data (a sample count), the learning processing part 38 uses as a part of the query type string as one piece of the learning data. The part of the query type string is a partial query type string including multiple query types consecutively arranged in the query type string. For example, if the query type string is “. . . , A, AAAA, A, TXT, NS, A, CNAME, AAAA, . . . ” as illustrated in FIG. 6, a partial query type string “. . . , A, AAAA, A, TXT” may be used the learning data. According to the exemplary embodiment, the query type at the end of the partial query type string (“TXT” in this example) is used as evaluation data and the rest of the partial query type string excluding the evaluation data (“. . . , A, AAAA, A” in this example) is used as entry learning data of the learning data.

The learning data as illustrated in FIG. 7 may be defined in accordance with the query type string. Referring to FIG. 7, the partial query type string “. . . , A, AAAA, A, TXT, NS” is set to be the learning data and “. . . , A, AAAA, A, TXT” out of the partial query type string is the entry learning data, and “NS” is the evaluation data.

Since the learner 34 processes only numerical values, the learning processing part 38 quantifies the learning data into numerical values in the form of a dictionary. A numerical value responsive to each query type is stored beforehand as a dictionary on the memory 32. The learning processing part 38 quantifies the learning data in accordance with the dictionary. For example, the query type “A” is converted to the numerical value “1”, the query type “AAAA” is converted to the numerical value “2”, and so on. According to the exemplary embodiment, the query type is directly input to the learner 34 for convenience of explanation. The numerical values listed in the dictionary are actually input to the learner 34.

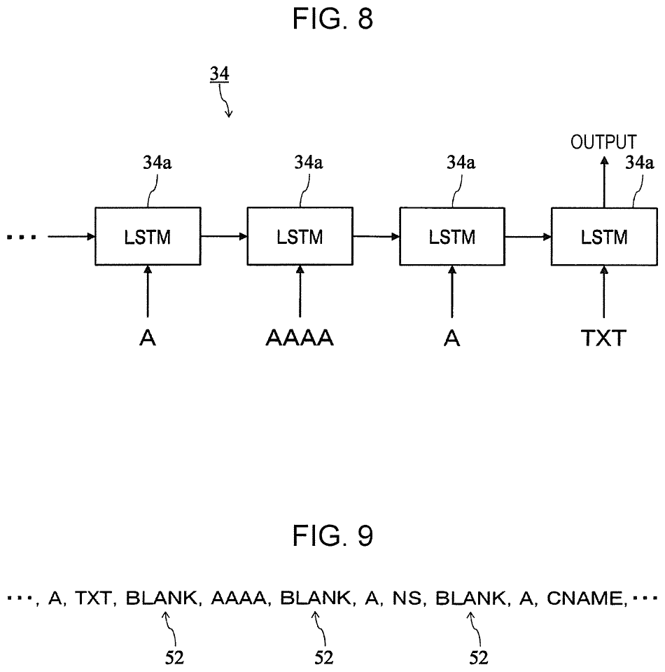

The learning processing part 38 inputs the entry learning data out of the learning data to the learner 34. As described above, the learner 34 includes the LSTM 34a. The LSTM 34a receives successively multiple query types included in the entry learning data. FIG. 8 illustrates how the entry learning data is successively input to the LSTM 34a. Referring to FIG. 8, for convenience of explanation, the entry learning data is “A, AAAA, A, TXT.” When the first query type “A” of the entry learning data is input to the LSTM 34a, the LSTM 34a outputs the feature of the query type “A.” The output is referred to as a hidden state vector. When the second query type “AAAA” of the entry learning data is input to the LSTM 34a, the LSTM 34a outputs a hidden state vector in view of both the output (hidden state vector) responsive to the first query “A” and the input query type “AAAA.” This hidden state vector accounts for not only the feature of the second query type “AAAA” but also the feature of the first query type “A.” This process is repeated. When the last query type “TXT” of the entry learning data is input to the LSTM 34a, the LSTM 34a provides an output that accounts for the features of the query types “A, AAAA, A” input heretofore and the feature of the input query type “TXT.”

According to the exemplary embodiment, the learner 34 outputs as a numerical value a probability that each of the query types is a query type that may follow the input entry learning data. For example, the probability that a query type following the input entry learning data is “A” is 0.95, the probability that a query type following the input entry learning data is “AAAA” is 0.03, the probability that a query type following the input entry learning data is “TXT” is 0.00000007, and so on.

A specific number of query types is to be included in the entry learning data in order for the learner 34 to predict the query type that may follow the entry learning data. The learning processing part 38 thus defines the learning data in the query type string such that the number of pieces of entry learning data is equal to or above a specific number.

The learning processing part 38 causes the learner 34 to learn in accordance with a difference between the output of the learner 34 and the evaluation data (namely, correct answer data).

The learning processing part 38 repeats the learning process as described above. The learner 34 having learned is enabled to output the feature of the query type string in accordance with the input query type string. According to the exemplary embodiment, the learner 34 accounts for the feature of the input entry learning data and thus outputs the probability that the query type may follow the entry learning data.

During the normal operation, in other words, when the originating terminal 12 is not infected with malware, the query type string acquired from multiple requests transmitted to the DNS server 18 in response to a request from the originating terminal 12 has typically a particular feature. For example, the query type string corresponding to a given originating terminal 12 has typically a pattern “A, AAAA, A, TXT.” The feature of the query type string may be different depending on the originating terminal 12. This is because the user using the originating terminal 12 typically behaves in a user's own particular pattern. For example, the user using the originating terminal 12 tends to access multiple destination hosts 14 in a specific order or tends to acquire information from the DNS server 18 in a specific order. In such a case, the query type string responsive to the originating terminal 12 indicates the tendency of the user. Specifically, the feature of the query type string represents the feature of the communication from the originating terminal 12. The learner 34 has probably learned the feature of the communication frequently performed from the originating terminal 12.

As described above, the learner 34 performs the learning process using the learning data including the entry learning data and evaluation data. However, the learner 34 learns the feature of the communication with the originating terminal 12 (e.g., the tendency of the communication) and does not learn the feature of the communication about the correct answer, namely, does not learn in accordance with teacher data indicating the feature of the communication. In this sense, the learner 34 may be understood as learning without the teacher data.

When the query type string is acquired in accordance with the communication log 16a, a time interval between two requests based on the dates of request included in the communication log 16a may be equal to or longer than a predetermined time period. In such a case, the learning processing part 38 may insert an element indicating a blank time between the query types of the two requests. In other words, the network device 16 transmits a first information request signal as a first request to the DNS server 18 in response to a request from the originating terminal 12 and then transmits a second information request signal as a second request to the DNS server 18 in response to a request from the originating terminal 12. In this case, if a difference between the transmission time of the first request and the transmission time of the second request is equal to or longer than a predetermined time period, the learning processing part 38 inserts the element (hereinafter referred to as a “special query type” in the exemplary embodiment) indicating the blank time between a first query type included in the first request and a second query type included in the second request in the query type string of the originating terminal 12.

FIG. 9 illustrates an example of the query type string into which an element having a blank time is inserted. With the special query type 52 inserted, the query type string indicates a transmission timing of the request transmitted from the network device 16 to the DNS server 18. Referring to FIG. 9, for example, the special query type 52 “BLANK” is inserted subsequent to the query types “A” and “TXT” and prior to the query type “AAAA.” It will be thus appreciated that the request including the query type “A” and the request including the query type “TXT” are consecutively transmitted and after the elapse of a predetermined period of time, the request including the query type “AAAA” is transmitted.

In the same learning process as described above, the learner 34 learns using the query type string with the special query type 52 inserted therewithin. For example, if the query type string “. . . , A, TXT, BLANK, AAAA” is input to the learner 34, the learner 34 may predict the special query type 52 “BLANK” at a higher probability as a query type subsequent to the query type string.

Turning back to FIG. 3, in a way similar to the process of the learning processing part 38, the fault detector part 40 acquires a target query type string serving as a detection target in accordance with the communication log 16a of the originating terminal 12 that serves as a target for the detection process of an unauthorized communication.

By inputting the acquired target query type string to the learner 34, the fault detector part 40 detects an unauthorized communication from the originating terminal 12 responsive to the target query type string. If a single learner 34 has learned on each originating terminal 12, the fault detector part 40 inputs to the learner 34 information identifying the originating terminal 12 (the IP address of the originating terminal 12 in the exemplary embodiment) together with the target query type string. If different learners 34 are prepared for respective originating terminals 12, the fault detector part 40 inputs the target query type string to the corresponding learner 34.

The learner 34 has learned the feature of the frequent communications from the originating terminal 12 as described above. By receiving the target query type string, the learner 34 determines whether the target query type string indicating the feature of the communication from the originating terminal 12 is the learned feature of the originating terminal 12 or identical to the “typical” feature of the communication from the originating terminal 12. The fault detector part 40 inputs the target query type string to the learner 34. If the feature of the communication of the originating terminal 12 indicated by the target query type string is different from the feature of the communication (typical feature of the communication) of the originating terminal 12 that has been learned, the fault detector part 40 determines that the communication from the originating terminal 12 is an unauthorized communication. The fault detector part 40 detects the unauthorized communication from the originating terminal 12 in this way. The fault detector part 40 thus detects the unauthorized communication in the manner free from defining the communication mode of the unauthorized communication in advance or learning the communication mode of the unauthorized communication.

The process of the fault detector part 40 is described in detail. In a way similar to the process of the learning processing part 38, the fault detector part 40 quantifies each query type in the target query type string into a numerical value in the form of a dictionary before inputting the target query type string to the learner 34. The fault detector part 40 may convert, into a common single numerical value, query types not included heretofore in the communication logs 16a of the originating terminal 12 corresponding to the target query type string. For example, if query types included heretofore into the communication logs 16a of a given originating terminal 12 are only “A,” “AAAA,” “TXT,” and “CNAME,” the query types are converted into different numerical values. The other query types, for example, “NS,” “DNSKEY,” and “MX” are converted into the same numerical value.

The fault detector part 40 defines a partial target query type string including a specific number or more query types from the head of the acquired target query type string and inputs the partial target query type string to the learner 34.

The learner 34 predicts the query type following the partial target query type string in accordance with the partial query type string and outputs a probability that each query type may follow the partial target query type string. Out of the probabilities output by the learner 34, the fault detector part 40 sets, as an individual score of a query type following the partial target query type string, the probability that the query type may follow the partial target query type string in the target query type string.

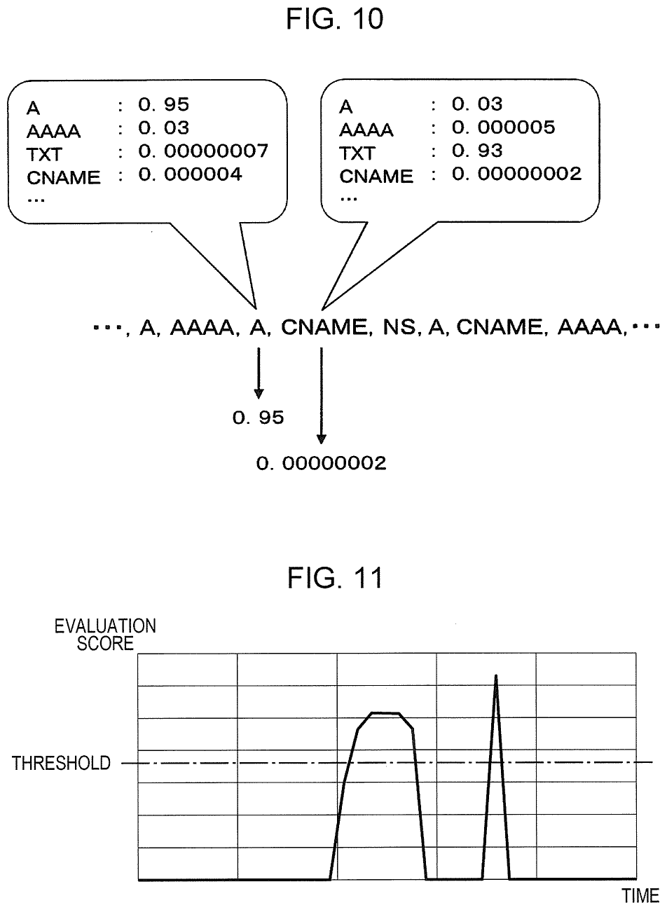

This operation is described more in detail with reference to FIG. 10. FIG. 10 illustrates the target query type string “. . . , A, AAAA, A, CNAME, NS, A, CNAME, AAAA, . . . ” The fault detector part 40 sets “. . . , A, AAAA” out of the target query type string to be the partial target query type string and inputs the partial target query type string to the learner 34. The learner 34 outputs a probability of the query type that may follow the partial target query type string in accordance with the partial target query type string “. . . , A, AAAA.” Referring to FIG. 10, for example, the probability that the query type following the partial target query type string is “A” is 0.95, the probability that the query type following the partial target query type string is “AAAA” is 0.03, the probability that the query type following the partial target query type string is “TXT” is 0.00000007, and the probability that the query type following the partial target query type string is “CNAME” is 0.000004.

The fault detector part 40 references the target query type string and identifies the query type following the input partial query type string “. . . , A, AAAA.” The fault detector part 40 herein identifies an actually following query type as “A.” Out of the probabilities of the query types output by the learner 34, the fault detector part 40 sets a probability of “0.95” of “A” as the identified actual following query type to be an individual score of the following query type “A.” As the individual score has a smaller value, the target query type string is faultier (namely, the communication is more different from the typical communication of the originating terminal 12).

The fault detector part 40 adds a subsequent query type to the partial target query type string. Referring to FIG. 10, the partial target query type string is “. . . , A, AAAA, A.” Similarly, based on the partial target query type string “. . . , A, AAAA, A,” the learner 34 outputs the probability of the query type following the partial target query type string. Referring to FIG. 10, the probability that the query type following the partial target query type string is “A” is 0.03, the probability that the query type following the partial target query type string is “AAAA” is 0.000005, the probability that the query type following the partial target query type string is “TXT” is 0.93, and the probability that the query type following the partial target query type string is “CNAME” is 0.00000002. Out of the probabilities of the query types output by the learner 34, the probability “0.00000002” of “CNAME” that is the query type actually following the partial target query type string “. . . A, AAAA, A” is the individual score of the following query type “CNAME.”

The fault detector part 40 adds the query types one by one to the partial target query type string and calculates the individual score of the following query type of the target query type string.

In accordance with the individual score calculated for each query type included in the target query type, the fault detector part 40 determines whether the communication from the originating terminal 12 indicated by the target query type is unauthorized, in other words, determines whether the originating terminal 12 is infected with malware.

A variety of methods for detecting the unauthorized communication from the originating terminal 12 in accordance with the individual score are contemplated. According to the exemplary embodiment, the fault detector part 40 detects the unauthorized communication from the originating terminal 12 in a method described below.

The fault detector part 40 extracts from the query types included in the target query types the query types having individual scores equal to or below a predetermined threshold (for example, 0.00001). Referring to the communication log 16a, the fault detector part 40 creates a fault log including the date of the request of the extracted query type and the individual score calculated for the query type. The fault log may further include the query type and the IP address of the originating terminal 12 corresponding to the query type.

For each specific time window (for example, 10 minutes), the fault detector part 40 calculates an evaluation score responsive to an individual score included in the fault log. According to the exemplary embodiment, the fault detector part 40 calculates the evaluation score in accordance with a measure called perplexity. Specifically, the fault detector part 40 sets a time window in time sequence, calculates −log₂P of each individual score P included in the fault log during the set time window (with the date of the request of the fault log falling within the time window), and calculates the mean of −log₂P of the individual scores P within the time window. The mean is the evaluation score of the time window. As the evaluation score is higher, the target query type string becomes faultier (specifically, the communication is more different from the typical communication of the originating terminal 12).

The fault detector part 40 calculates the evaluation score of each time window by shifting the setting time of the time window bit by bit (for example, in steps of 1 minute). The fault detector part 40 detects the unauthorized communication from the originating terminal 12 in accordance with the evaluation score of each time window. For example, the fault detector part 40 determines that the communication from the originating terminal 12 is unauthorized if the time windows having an evaluation score equal to or higher than a threshold appear consecutively by a specific number of times.

Referring to FIG. 11, the fault detector part 40 may output the evaluation scores of the time windows in graph. In the graph in FIG. 11, the horizontal axis represents the start time and end time of the time window and the vertical axis represents the evaluation score. The graph is viewed by the administrator of the network device 16 or the administrator of the originating terminal 12. The administrator may thus recognize that the communication from the originating terminal 12 is unauthorized or the originating terminal 12 is infected with malware.

If the learner 34 has learned the learning data including the special query type 52 indicating the blank time, the fault detector part 40 acquires the target query type string including the special query type indicating the blank time in a way similar to the process of the learning processing part 38. The fault detector part 40 inputs the target query type string including the special query type indicating the blank time to the learner 34 that has learned using the target query type string including the special query type indicating the blank time. The fault detector part 40 may thus detect an unauthorized communication from the originating terminal 12 by accounting for transmission intervals of the query types (namely, the requests) from the originating terminal 12. The tendency of the communication during a normal operation (with the originating terminal 12 not infected with malware) may now considered. For example, the originating terminal 12 tends to communicate to transmit multiple requests to the DNS server 18 at time intervals of a predetermined time length or more and then may now be infected with malware. The malware may imitate the tendency of the originating terminal 12 during the normal operation or the tendency of the communication of the malware may coincide with the same pattern as the tendency of the communication during the normal communication. If the malware transmits multiple requests consecutively without intervals, the target query type string obtained from the unauthorized communication of the malware does not include the special query type indicating the blank time. The communication is thus detected as an unauthorized communication.

Turning back to FIG. 3, the fault responding part 42 performs a variety of processes in response to the fault detector part 40 having detected an unauthorized communication from the originating terminal 12. For example, the fault responding part 42 controls the network device 16, thereby blocking the communication from the originating terminal 12. The fault detector part 40 transmits an alert output instruction to the originating terminal 12 to cause the originating terminal 12 to output an alert. The fault detector part 40 may output an alert notice to the administrator of the originating terminal 12 or an administrator terminal used by the administrator of the originating terminal 12.

According to the exemplary embodiment, the learner 34 learns with the learning processing part 38 in the security server 20. Alternatively, the learner 34 may learn with another apparatus and the learner 34 having learned may be stored on the memory 32. According to the exemplary embodiment, the security server 20 has the functions of the learning processing part 38, fault detector part 40, and fault responding part 42. Alternatively, the network device 16 may have these functions.

In the exemplary embodiment above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to detect an unauthorized communication from an originating terminal by inputting a target query type string of the originating terminal serving as a detection target to a learner that has learned a feature of a query type string of the originating terminal through unsupervised learning with the query type string used as learning data, the query type string including query types arranged in time sequence and included in an information request signal that is transmitted to a domain name system (DNS) server in response to a request of the originating terminal.

2. The information processing apparatus according to claim 1, wherein the processor is configured to, in response to a time period between a transmission time of a first information request signal and a transmission time of a second information request signal being equal to or longer than a specific time period, insert in the query type string and the target query type string an element having a blank time between a first query type included in the first information request signal and a second query type included in the second information request signal.

3. A non-transitory computer readable medium storing a program causing a computer to execute a process for processing information, the process comprising detecting an unauthorized communication from an originating terminal by inputting a target query type string of the originating terminal serving as a detection target to a learner that has learned a feature of a query type string of the originating terminal through unsupervised learning with the query type string used as learning data, the query type string including query types arranged in time sequence and included in an information request signal that is transmitted to a domain name system (DNS) server in response to a request of the originating terminal.

4. An information processing apparatus comprising means for detecting an unauthorized communication from an originating terminal by inputting a target query type string of the originating terminal serving as a detection target to a learner that has learned a feature of a query type string of the originating terminal through unsupervised learning with the query type string used as learning data, the query type string including query types arranged in time sequence and included in an information request signal that is transmitted to a domain name system (DNS) server in response to a request of the originating terminal.
